(19) United States
(12) Patent Application Publication
(10) Pub. No.: US 2013/0050036 A1
(43) Pub. Date: Feb. 28, 2013

(54) ANTENNA DEVICE AND ELECTRONIC APPARATUS INCLUDING ANTENNA DEVICE

(71) Applicants: Ippei Kashiwagi, Fuchu-shi (JP); Koichi Sato, Tachikawa-shi (JP); Hiroyuki Hotta, Hamura-shi (JP)

(72) Inventors: Ippei Kashiwagi, Fuchu-shi (JP); Koichi Sato, Tachikawa-shi (JP); Hiroyuki Hotta, Hamura-shi (JP)

(21) Appl. No.: 13/460,350

(22) Filed: Apr. 30, 2012

(30) Foreign Application Priority Data
Aug. 30, 2011 (JP) 2011-187569

(51) Int. Cl. H01Q 1/36

(52) U.S. Cl. 343/749

(57) ABSTRACT

According to one embodiment; an antenna device according to this embodiment includes the first antenna element formed from a folded monopole element and a capacitor element. The first antenna element has a first end connected to a feeding terminal, a second end connected to the first ground terminal, and a middle portion folded, with a stub being provided between the forward portion and backward portion formed by this folding. The capacitor element is inserted between the stub and the above feeding terminal of the forward portion of the first antenna element.

### CROSS-REFERENCE TO RELATED APPLICATIONS

This application is based upon and claims the benefit of priority from prior Japanese Patent Application No. 2011-187569, filed Aug. 30, 2011, the entire contents of which are incorporated herein by reference.

### FIELD

Embodiments described herein relate generally to an antenna device and an electronic apparatus including the antenna device.

### BACKGROUND

Recently, the dimensions and weight of the housings of portable electronic apparatuses typified by cellular phones, smart phones, PDAs (Personal Digital Assistants), tablet-type terminals, and navigation terminals have been required to be reduced, from the viewpoint of compactness and lightweightness. Accordingly, demands have arisen for more compact antenna devices. It has also been required to allow a single portable terminal apparatus to communicate with a plurality of radio systems using different frequency bands.

Conventionally, therefore, as disclosed in, for example, patent literature 1, there has been proposed a multifrequency antenna device in which the second antenna element formed from a monopole element is provided at a position close to the feeding point of the first antenna element formed from a folded element with a stub in a direction opposite to the first antenna element.

However, it is difficult to expand the impedance band of the first antenna element of the conventional multifrequency antenna device itself. In order to expand the band, it is necessary to add the third antenna element to couple the first antenna element to the second antenna element. This inevitably increases the size of the antenna device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view showing the arrangement of an electronic apparatus including an antenna device according to the first embodiment;

FIG. 2 is a view showing a current distribution in the antenna device shown in FIG. 1;

FIG. 3 is a graph showing the VSWR frequency characteristic of the antenna device shown in FIG. 1 in comparison with that of the device without a capacitor element;

FIG. 4 is a Smith chart showing the impedance characteristic of the antenna device shown in FIG. 1 in comparison with that of the device without a capacitor element;

FIG. 5 is a view showing the best installation position of a capacitor element in the antenna device shown in FIG. 1;

FIG. 6 is a view for explaining the possible installation range of the capacitor element in the antenna device shown in FIG. 1;

FIG. 7 is a view for explaining an undesirable installation position of the capacitor element in the antenna device shown in FIG. 1;

FIG. 8 is a graph showing the VSWR frequency characteristic of the arrangement shown in FIG. 5 in comparison with that of the arrangement shown in FIG. 7;

FIG. 9 is a graph showing the VSWR frequency characteristic of the arrangement shown in FIG. 5 in comparison with that of the arrangement shown in FIG. 6;

FIG. 10 is a view showing the arrangement of an electronic apparatus including an antenna device according to the second embodiment;

FIG. 11 is a Smith chart showing the impedance characteristic of the antenna device shown in FIG. 10 in comparison with that of the device without a capacitor element;

FIG. 12 is a view showing the arrangement of an electronic apparatus including an antenna device according to the third embodiment;

FIG. 13 is a view showing a modification of the antenna device shown in FIG. 10;

FIG. 14 is a view showing the arrangement of an antenna device according to the fourth embodiment;

FIGS. 15A, 15B, 15C, 15D, and 15E are views showing the first modification group of a folded monopole element;

FIGS. 16A, 16B, 16C, 16D, and 16E are views showing the second modification group of the folded monopole element;

FIGS. 17A, 17B, 17C, 17D, and 17E are views showing the first modification group of a monopole element;

FIGS. 18A, 18B, 18C, and 18D are views showing the second modification group of the monopole element;

FIGS. 19A, 19B, 19C, 19D, and 19E are views showing the first modification group of a passive element;

FIGS. 20A, 20B, 20C, and 20D are views showing the second modification group of the passive element; and

FIGS. 21A, 21B, 21C, 21D, and 21E are views showing the third modification group of the passive element.

### DETAILED DESCRIPTION

Various embodiments will be described hereinafter with reference to the accompanying drawings.

In general, according to one embodiment, an antenna device according to this embodiment includes the first antenna element formed from a folded monopole element and a capacitor element. The first antenna element has a first end connected to a feeding terminal, a second end connected to the first ground terminal, and a middle portion folded, with a stub being provided between the forward portion and backward portion formed by this folding. The capacitor element is inserted between the stub and the above feeding terminal of the forward portion of the first antenna element.

### First Embodiment

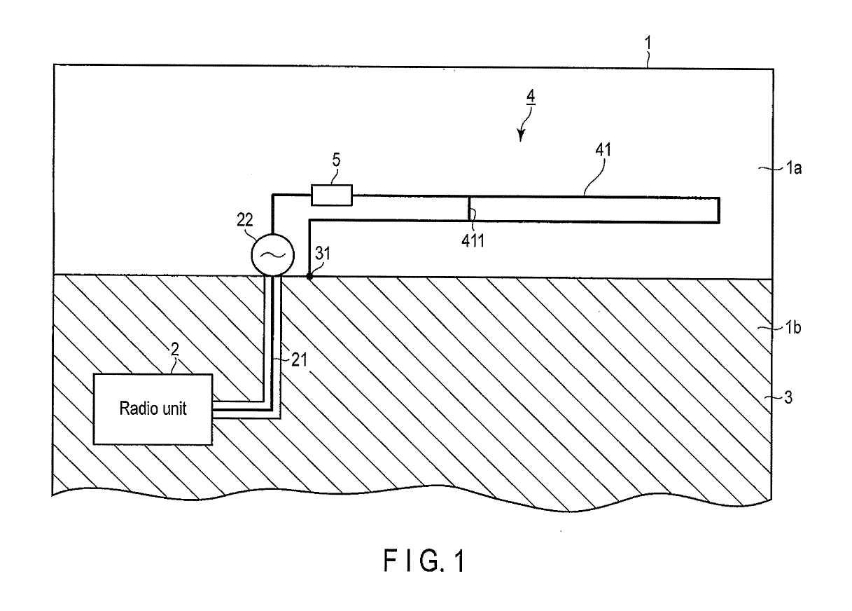

FIG. 1 is a view showing the arrangement of an electronic apparatus including an antenna device according to the first embodiment. This electronic apparatus is formed from a notebook personal computer or television receiver including a radio interface, and includes a printed wiring board 1 accommodated in the housing (not shown).

Note that the electronic apparatus may be a portable terminal such as a cellular phone, smart phone, PDA (Personal Digital Assistant), tablet-type terminal, or navigation terminal instead of a notebook personal computer or television receiver. In addition, the printed wiring board 1 may be one that uses part of a metal housing or a metal member such as a copper foil.

The printed wiring board 1 described above includes a first area 1a and a second area 1b. An antenna device 4 is provided in the first area 1a. A ground pattern 3 is formed in the second area 1b. In addition, first and second ground terminals 31 and 32 are provided in the second area 1b. Note that a plurality of circuit modules necessary to form the electronic apparatus are mounted on the lower surface side of the printed wiring board 1. The circuit modules include a radio unit 2.

The radio unit 2 has a function of transmitting and receiving radio signals by using the channel frequency assigned to a radio system as a communication target. In addition, in the first area 1a, a feeding terminal (feeding point) 22 is provided, and the radio unit 2 is connected to the feeding terminal 22 via a feeding pattern 21.

The antenna device 4 has the following arrangement.

The antenna device 4 includes a folded monopole element 41 as the first antenna element. The folded monopole element 41 is formed from a conductive pattern having a shape obtained by folding the element in a hairpin form at a position almost dividing the entire element into two portions, with one end of the element being connected to the feeding terminal 22, and the other end being connected to the first ground terminal 31. A stub 411 is provided between the forward portion and backward portion formed by folding the above element. More specifically, the stub 411 is connected between an arbitrary point between the feeding terminal 22 and the middle position on the forward portion and an arbitrary point between the first ground terminal 31 and the middle position on the backward portion.

The element length of the folded monopole element 41 with the stub, i.e., the electrical length from the feeding terminal 22 to the first ground terminal 31 through the folding position, is set to nearly ½ a wavelength λ₁ corresponding to a preset first resonance frequency f₁. Note that the first resonance frequency f₁ is set to the band (700 MHz to 900 MHz) used by a radio system using LTE (Long Term Evolution). The distance between the feeding terminal 22 and the first ground terminal 31 is set equal to or less than almost ⅕ the wavelength λ₁ corresponding to the first resonance frequency f₁.

In the folded monopole element 41 with the stub described above, a capacitor element 5 is inserted between the stub 411 and the feeding terminal 22 of the forward portion. A capacitance C [pF] of the capacitor element 5 is set within the range of 1/ω₁C<250 [Ω], where ω₁ is an angular frequency corresponding to the first resonance frequency f₁. Note however that in the 900-MHz band, in order to maintain a VSWR less than “5”, which is a threshold, the capacitance C of the capacitor element 5 needs to be set to about 0.7 pF.

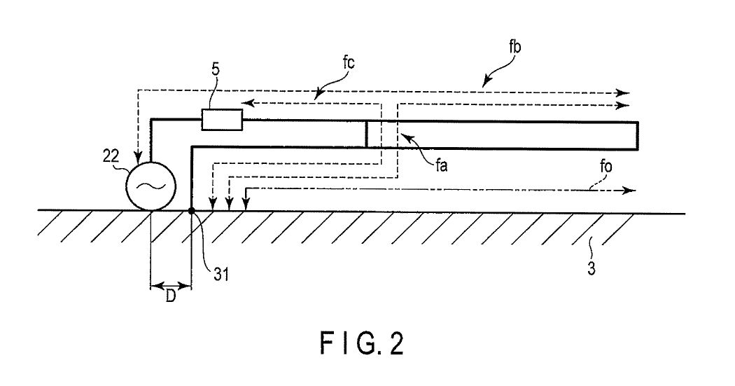

With this arrangement, as shown in FIG. 2, providing the capacitor element 5 generates, on the folded monopole element 41 with the stub, a first resonance mode fa based on the zone extending from the first ground terminal 31 to the capacitor element 5 through the stub 411, a second resonance mode fb based on the zone extending from the first ground terminal 31 to the folded end through the stub 411, and a third resonance mode fc based on the zone extending from the feeding terminal 22 to the folding position through the capacitor element 5. Using the three resonance modes fa, fb, and fc can expand the impedance band of the antenna device.

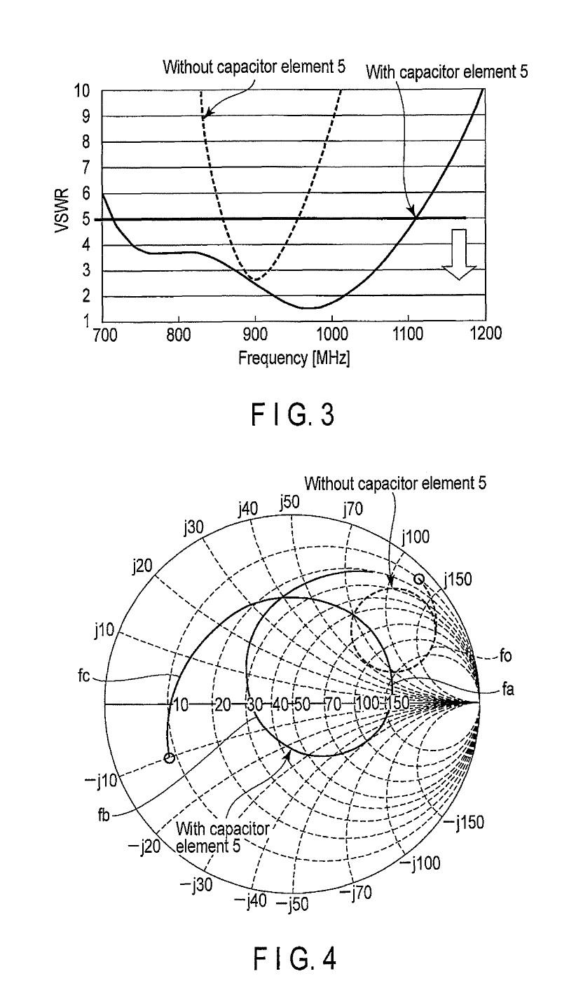

FIG. 4 is a Smith chart showing the impedance characteristic obtained by the antenna device according to this embodiment in comparison with that obtained by the device without the capacitor element 5. FIG. 3 is a graph showing the frequency characteristic of a voltage standing wave ratio (VSWR) obtained when the three resonance modes fa, fb, and fc described above are combined, in comparison with that obtained without the capacitor element 5. As is obvious from FIG. 3, providing the capacitor element 5 expands the resonance band to the band of 720 MHz to 1,100 MHz.

When the capacitor element 5 is not provided, a resonance mode fo is generated in the zone extending from the first ground terminal 31 of the backward portion to the folded end, but the resonance mode fa is not generated, as shown in FIG. 2. For this reason, the expansion of the resonance band cannot be expected.

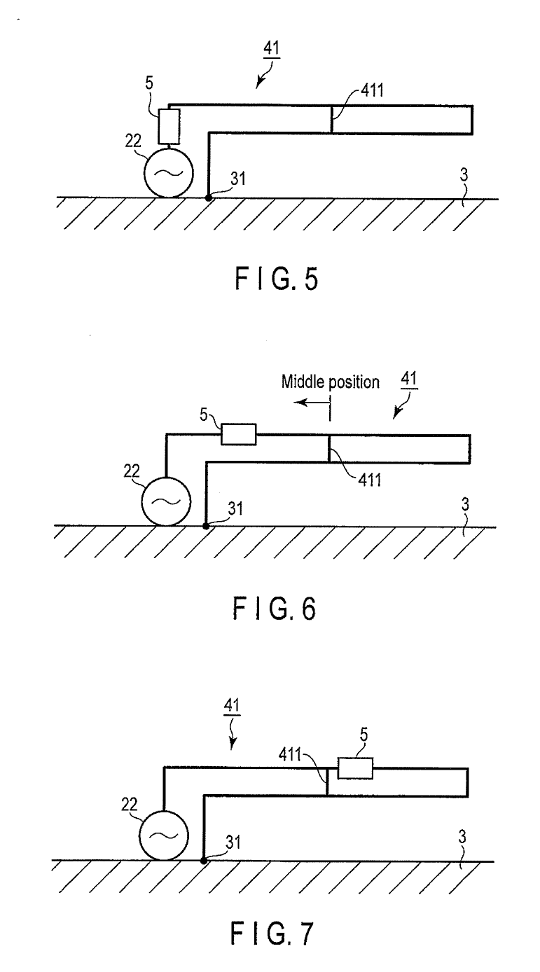

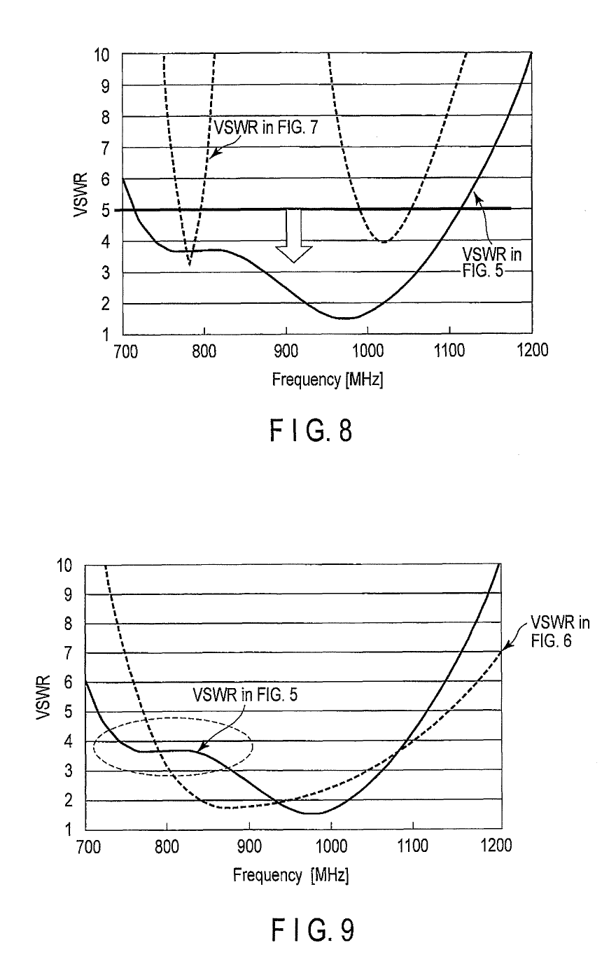

Note that the resonance band of the antenna device changes in accordance with the installation position of the capacitor element 5. FIGS. 8 and 9 show the VSWR frequency characteristics obtained, respectively, by inserting the capacitor element 5 close to the feeding terminal 22 as shown in FIG. 5, by inserting the capacitor element 5 at an intermediate position in the zone extending from the feeding terminal 22 to the stub 411 as shown in FIG. 6, and by inserting the capacitor element 5 between the stub 411 and the folded end as shown in FIG. 7.

That is, it is possible to expand the resonance band regardless of the position of the capacitor element 5 between the feeding terminal 22 and the stub 411. The closer to the position of the capacitor element 5 to the feeding terminal 22, in particular, the larger the band expansion effect in a low-frequency region of 800 MHz or less. Note that when the capacitor element 5 is inserted between the stub 411 and the folded end, as shown in FIG. 7, no band expansion effect can be obtained, as shown in FIG. 8.

As described in detail above, in the first embodiment, the capacitor element 5 is inserted in the zone extending from the feeding terminal 22 of the folded monopole element 41 with the stub to the stub 411. This can therefore newly generate the resonance mode fa in the zone extending from the first ground terminal 31 of the folded monopole element 41 with the stub to the capacitor element 5 through the stub 411. This makes it possible to expand the resonance band of the antenna device in spite of the very simple arrangement in which the capacitor element 5 is inserted.

A distance D between the first ground terminal 31 and the feeding terminal 22 of the folded monopole element 41 with the stub is set equal to or less than ⅕ the wavelength λ₁ corresponding to the first resonance frequency f₁. This setting allows the folded monopole element 41 with the stub to generate series resonance. This makes it possible to effectively expand the resonance band. When the distance D is set to be long, sufficient series resonance is not generated, resulting in the inability to set the first resonance frequency f₁.

### Second Embodiment

An antenna device according to the second embodiment is obtained by adding a monopole element 42 to the above folded monopole element 41 with the stub.

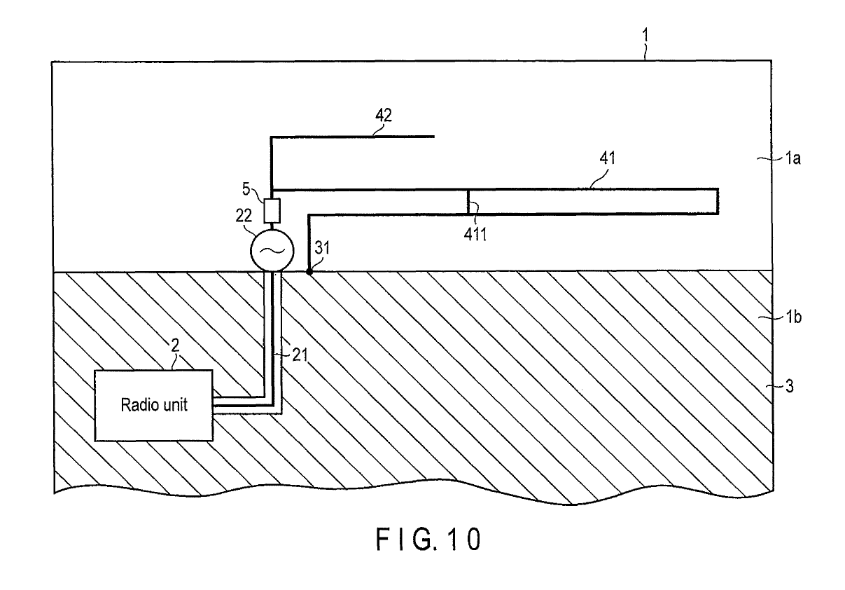

FIG. 10 is a view showing the arrangement of an electronic apparatus including the antenna device according to the second embodiment. The same reference numerals as in FIG. 10 denote the same parts in FIG. 1, and a detailed description of them will be omitted. The antenna device according to the second embodiment includes the folded monopole element 41 as the first antenna element and the monopole element 42 as the second antenna element. Of the elements 41 and 42, the folded monopole element 41 is located closest to a ground pattern 3, and the monopole element 42 is located outside the folded monopole element 41.

The monopole element 42 is formed from an L-shaped conductive pattern. The monopole element 42 has a proximal end connected to the feeding terminal 22 through part of the folded monopole element 41 with the stub and a capacitor element 5, and the second end open. The element length of the monopole element 42, i.e., the length from the feeding terminal 22 to the distal end, is set to a length almost ¼ a wavelength λ₂ corresponding to a second resonance frequency f₂. Note that the second resonance frequency f₂ is set, for example, in the band (1.7 GHz to 1.9 GHz) used by a 3G standard radio system.

According to the second embodiment, adding the monopole element 42 to the folded monopole element 41 with the stub allows the monopole element 42 to cover, for example, the band (1.7 GHz to 1.9 GHz) used by a 3G standard radio system as well as allowing the folded monopole element 41 with the stub to cover the band (LTE (Long Term Evolution)) of 700 MHz to 900 MHz.

In addition, since both the folded monopole element 41 with the stub and the monopole element 42 are connected to the feeding terminal 22 via the capacitor element 5, it is possible to adjust the impedance of the monopole element 42 to a value near 50Ω while expanding the resonance band of the folded monopole element 41 with the stub. This can improve the matching of the monopole element 42.

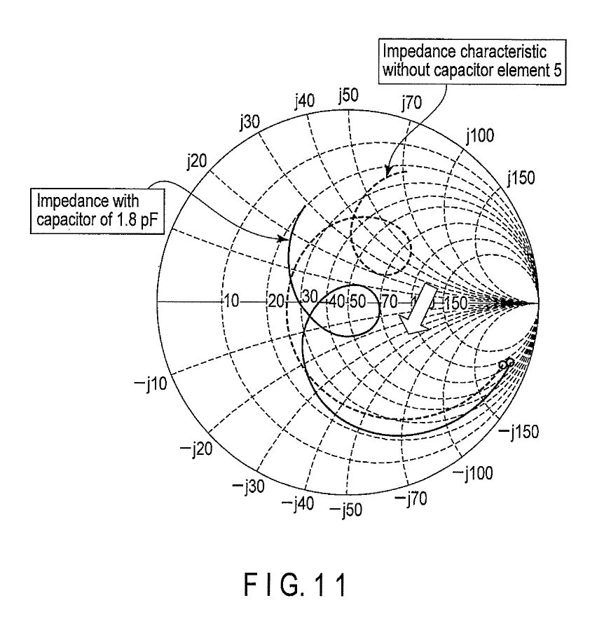

FIG. 11 is a Smith chart showing the impedance characteristic at the resonance frequency f₂ of the monopole element 42 and, more specifically, the impedance characteristic with the capacitor element 5 in comparison with that without the capacitor element 5. As is also obvious from FIG. 11, providing the capacitor element 5 can adjust the impedance of the monopole element 42 to a value near 50 Ω.

### Third Embodiment

An antenna device according to the third embodiment is obtained by adding a monopole element 42 to a folded monopole element 41 with a stub and further adding a passive element 43 to the resultant structure.

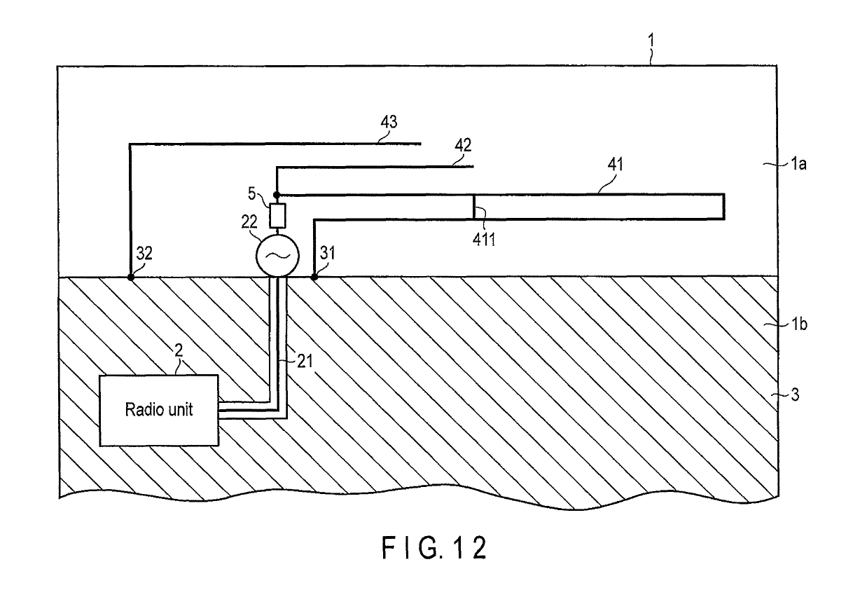

FIG. 12 is a view showing the arrangement of an electronic apparatus including the antenna device according to the third embodiment. The same reference numerals as in FIG. 12 denote the same parts in FIGS. 1 and 10, and a detailed description of them will be omitted.

The antenna device according to the third embodiment includes the folded monopole element 41 as the first antenna element, the monopole element 42 as the second antenna element, and the passive element 43 as the third antenna element. Of these elements 41, 42, and 43, the folded monopole element 41 is located closest to a ground pattern 3, and the monopole element 42 and the passive element 43 are sequentially arranged outside the folded monopole element 41 in the order named in the direction to increase the distance from the ground pattern 3.

The passive element 43 is formed from an L-shaped conductive pattern, and has a proximal end connected to a second ground terminal 32, and a distal end open. The element length of the passive element 43, i.e., the electrical length from the second ground terminal 32 to the distal end, is set to nearly ¼ a wavelength λ₃ corresponding to a preset third resonance frequency f₃. In addition, at least part of the horizontal portion of the passive element 43 which is located on the distal end side is disposed to be parallel with the horizontal portion of the monopole element 42 so as to allow current coupling between them. The third resonance frequency f₃ is set in a band near a first resonance frequency f₁ or second resonance frequency f₂ to expand, for example, the band used by a radio system using the above LTE or the band used by a 3G standard radio system.

The element lengths and relative positions of the folded monopole element 41 with the stub, monopole element 42, and passive element 43 are set to make the first, second, and third resonance frequencies f₁, f₂, and f₃ have the relationship represented by f₁<f₂<f₃ or f₁<f₃<f₂. This is because the closer to the ground pattern 3, the larger the current and the lower the impedance, and it is desired to generate the lowest resonance frequency in the folded monopole element 41 with the stub.

As described above, in the third embodiment, the folded monopole element 41 with the stub is located closest to the ground pattern 3, and the monopole element 42 and the passive element 43 are sequentially arranged outside the folded monopole element 41 in the order named in the direction to increase the distance from the ground pattern 3. This arrangement generates no parallel resonance between the series resonance bands between the folded monopole element 41 with the stub, the monopole element 42, and the passive element 43, thereby preventing an increase in mismatch loss or a deterioration in radiation efficiency. This prevents interference between the passive element 43, the folded monopole element 41, and the monopole element 42, and hence can further expand the band used by a radio system for LTE or the band used by a 3G standard radio system.

That is, the third embodiment allows the third resonance frequency f₃ to be independently set in an arbitrary band near the first or second resonance frequency f₁ or f₂ without causing interference between the folded monopole element 41 and the monopole element 42 by merely setting the element length of the passive element 43 to an arbitrary length. This can further expand the band of the first or second resonance frequency f₁ or f₂.

In addition, as in the second embodiment, both the folded monopole element 41 with the stub and the monopole element 42 are connected to the feeding terminal 22 via the capacitor element 5. This can expand the resonance band of the folded monopole element 41 with the stub and adjust the impedance of the monopole element 42 to a value near 50Ω. This makes it possible to improve the matching of the monopole element 42.

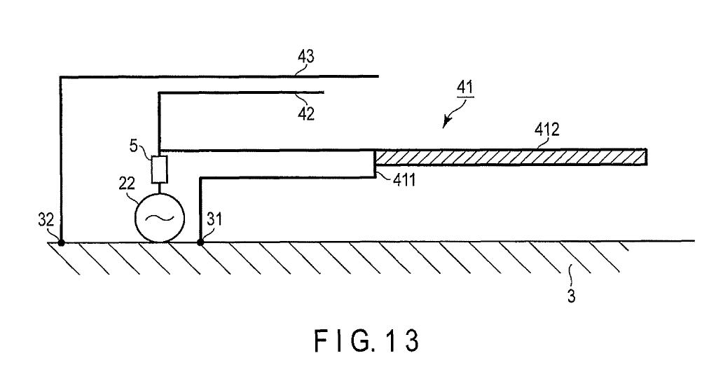

The following arrangement is conceivable as a modification of the antenna device according to the third embodiment. FIG. 13 is a view showing the arrangement. Note that the same reference numerals as in FIG. 12 denote the same parts in FIG. 13, and a detailed description of them will be omitted.

The folded monopole element 41 with the stub is configured such that a zone from the installation position of a stub 411 to a folding position is formed by one element 412 having a plate-like shape. Note that the element 412 may have a rod-like shape instead of a plate-like shape.

This arrangement can increase the structural strength of the zone from the stub 411 of the folded monopole element 41 to the folding position. This makes it possible to increase the yield in forming antenna devices.

### Fourth Embodiment

An antenna device according to the fourth embodiment is configured such that one side of a ground pattern 3 is formed in a staircase pattern, a feeding cable 23 is wired along a side of the ground pattern 3, and the core of the feeding cable 23 is made to protrude from a side 33 formed in the above staircase pattern into a first area 1a so as to be connected to a feeding terminal 22.

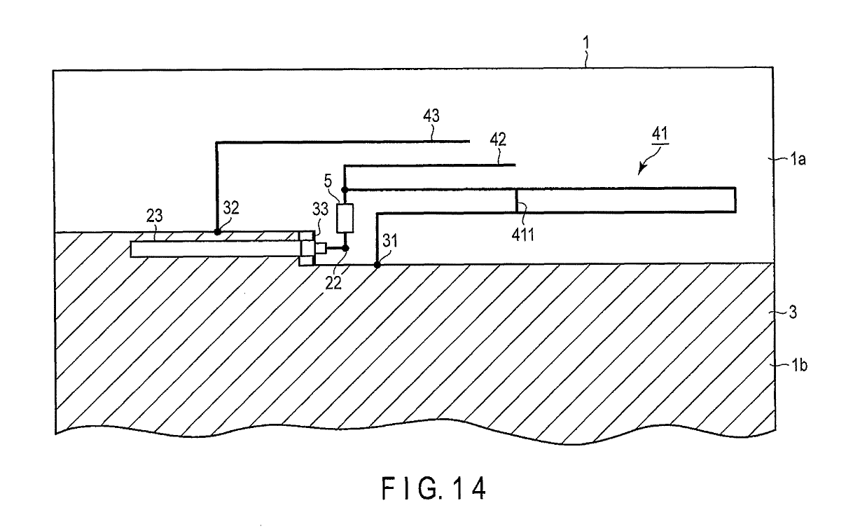

FIG. 14 is a view showing the arrangement of the antenna device according to the fourth embodiment. The same reference numerals as in FIG. 12 denote the same parts in FIG. 14, and a detailed description of them will be omitted.

A side of the ground pattern 3 formed on a printed wiring board 1 which is in contact with the first area 1a is formed in a staircase pattern (in the form of a crank). The feeding cable 23 is disposed along a side of a portion on the ground pattern 3 which protrudes into the first area 1a. The feeding cable 23 is formed from a coaxial cable including a shielded conductive wire 24. The shielded wire is grounded at the ground terminal 33 provided on the ground pattern 3. The feeding terminal 22 is provided at a position on the first area 1a which faces the ground terminal 33 of the ground pattern 3. The core of the feeding cable 23 protrudes from the ground terminal 33 into the first area 1a, and is connected to the feeding terminal 22. Note that soldering is used for both the connection of the shielded wire to the ground terminal 33 and the connection of the core to the feeding terminal 22.

This arrangement allows to dispose the feeding cable 23 along a side of the ground pattern 3 without bending it into an unnatural shape. This can improve the mounting efficiency of electronic parts per unit area by effectively using the space of the printed wiring board 1, thereby further improving the reliability of the device.

As in the third embodiment, connecting both a folded monopole element 41 with a stub and a monopole element 42 to the feeding terminal 22 via a capacitor element 5 can adjust the impedance of the monopole element 42 to a value near 50Ω while expanding the resonance band of the folded monopole element 41 with the stub. This makes it possible to improve the matching of the monopole element 42.

### Other Embodiments

### (1) Modification of Folded Monopole Element 41 with

Stub

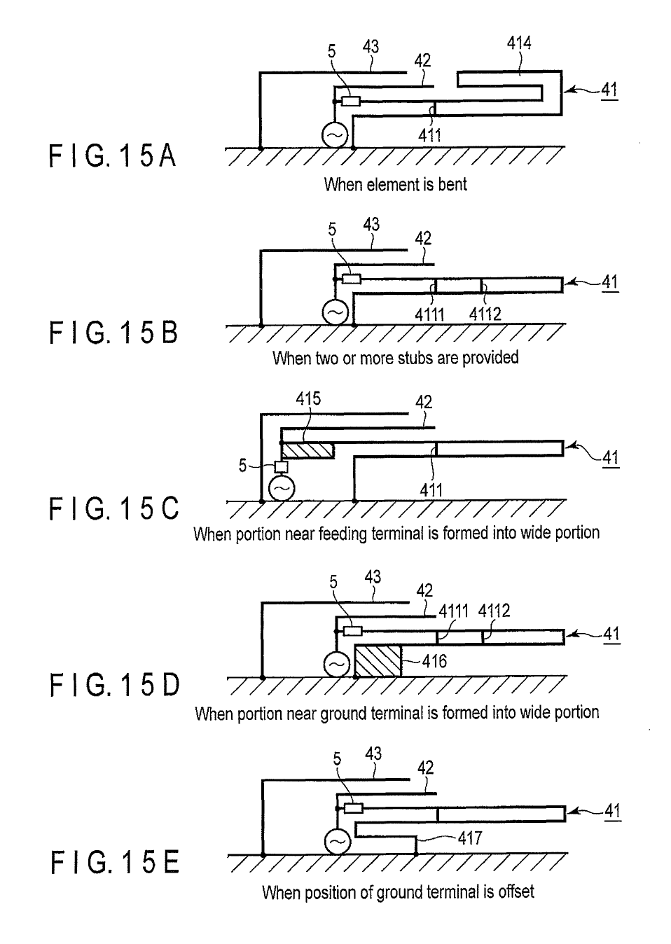

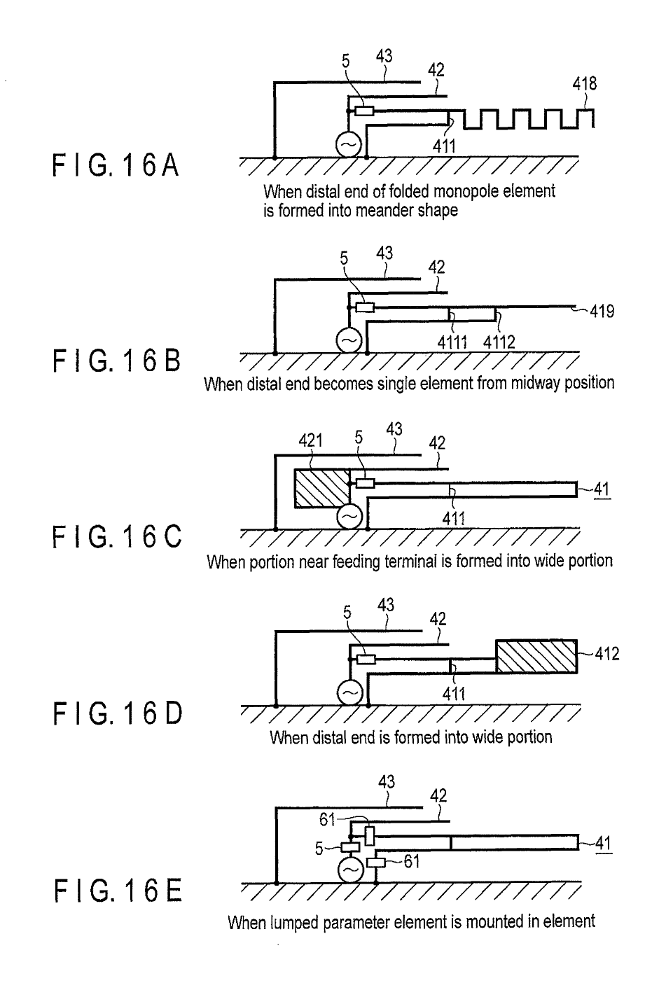

FIGS. 15A, 15B, 15C, 15D, and 15E and FIGS. 16A, 16B, 16C, 16D, and 16E show various modifications of the folded monopole element 41 with the stub.

The antenna device shown in FIG. 15A is obtained by folding a zone from the installation position of a stub 411 of the folded monopole element 41 with the stub to the folded end in the direction of a monopole element 42. This arrangement can reduce the installation space in the element length direction of the antenna device even when the element length of the folded monopole element 41 with the stub is long.

The antenna device shown in FIG. 15B is obtained by providing a plurality of stubs 4111 and 4112 between the forward portion and backward portion formed by folding the folded monopole element 41 with the stub. This arrangement can implement multiple resonance. Note that the number of stubs is not limited to two and may be three or more.

The antenna device shown in FIG. 15C is obtained by forming a portion of the folded monopole element 41 with the stub which is located close to a feeding terminal 22 into a wide portion. In this case, the capacitor element 5 is connected between the portion formed into the wide portion and the feeding terminal 22.

The antenna device shown in FIG. 15D is obtained by forming a portion of the folded monopole element 41 with the stub which is located close to the first ground terminal 31 into a wide portion.

The antenna device shown in FIG. 15E is obtained by offsetting the grounding position of the folded monopole element 41 with the stub with respect to the ground pattern 3, i.e., the position of the first ground terminal 31, in the direction of the distal end of the folded monopole element 41 with the stub.

The antenna device shown in FIG. 16A is obtained by forming a zone from the installation position of the stub 411 of the folded monopole element 41 with the stub to the folded end by using one element and forming it into a meandering shape.

The antenna device shown in FIG. 16B is obtained by providing a plurality of stubs 4111 and 4112 between the forward portion and backward portion formed by folding the folded monopole element 41 with the stub, and forming a zone from the installation position of the stub 4112 to the folded end by using one element.

The antenna device shown in FIG. 16C is obtained by forming a portion 421 of the folded monopole element 41 with the stub and of the monopole element 42 which is located close to the feeding terminal 22 into a wide portion.

The antenna device shown in FIG. 16D is obtained by forming, by using a plate-like wide element 412, a portion of the zone from the installation position of the stub 411 of the folded monopole element 41 with the stub to the folded end, which portion extends from the middle portion to the distal end portion.

The antenna device shown in FIG. 16E is obtained by inserting the capacitor element 5 in a portion close to the folded monopole element 41 with the stub and the feeding terminal 22 of the monopole element 42, and also inserting lumped parameter elements 61 and 62 in the zone extending from the branching position of the folded monopole element 41 with the stub and the monopole element 42 to the installation position of the stub 411 and in a portion of the folded monopole element 41 with the stub close to the first ground terminal 31. The lumped parameter elements 61 and 62 are formed from inductors, and have a function of increasing the electrical length of the folded monopole element 41 with the stub.

(2) Modifications of Monopole Element 42

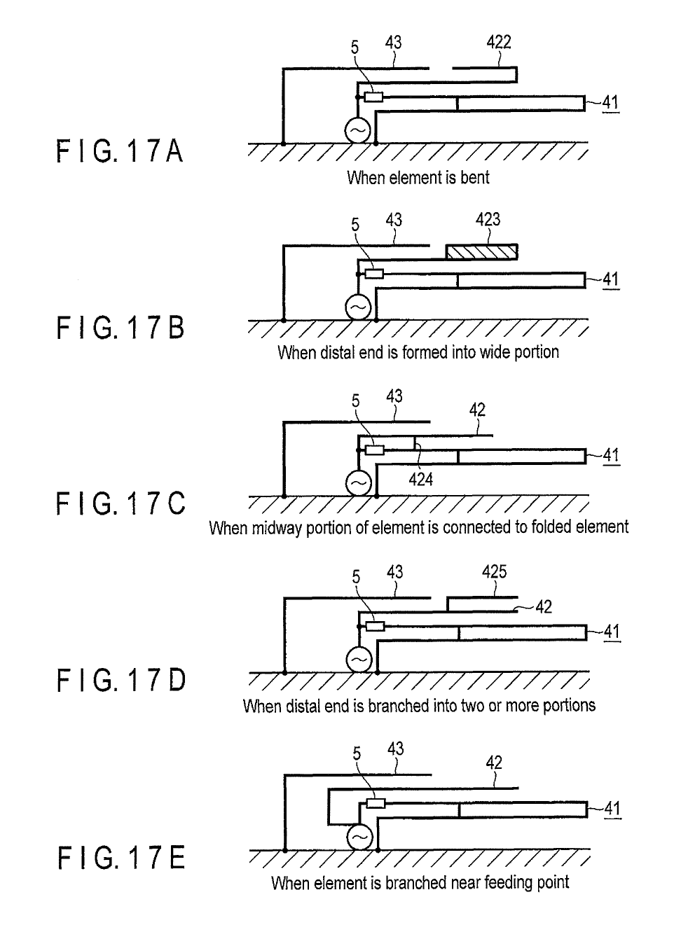

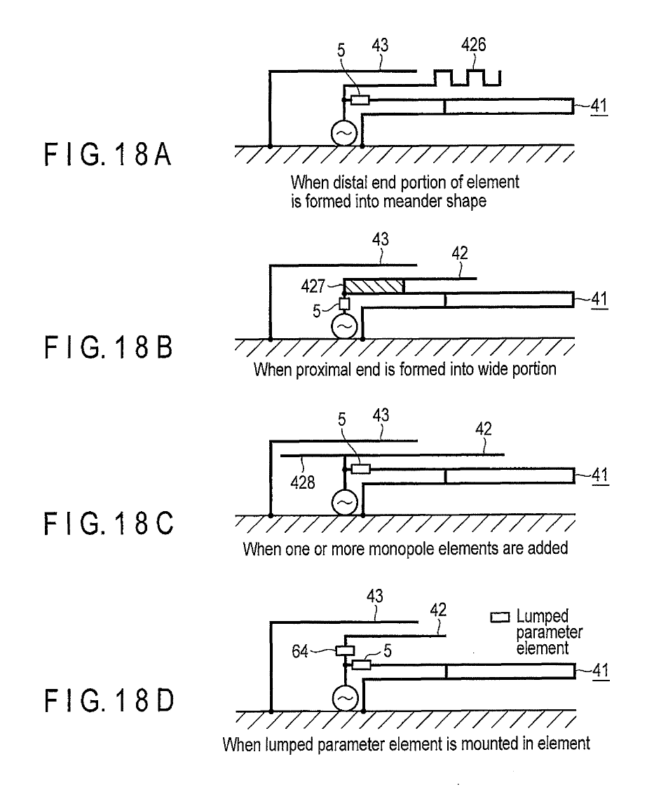

FIGS. 17A, 17B, 17C, 17D, and 17E and FIGS. 18A, 18B, 18C, and 18D show various modifications of the monopole element 42.

The antenna device shown in FIG. 17A is obtained by folding the distal end portion of the monopole element 42 in the direction of the passive element 43. This can reduce the installation space in the element length direction of the antenna device even when the element length of the monopole element 42 is long.

The antenna device shown in FIG. 17B is obtained by forming a distal end portion 423 of the monopole element 42 into a wide portion.

The antenna device shown in FIG. 17C is obtained by connecting the monopole element 42 to the folded monopole element 41 with the stub through a connection element 424 at a position where the monopole elements are parallel with each other.

The antenna device shown in FIG. 17D is obtained by branching the distal end portion of the monopole element 42 so as to provide an additional element 425. Although FIG. 17D exemplifies the case in which the device includes one additional element 425, the device may include two or more additional elements.

The antenna device shown in FIG. 17E is obtained by branching the monopole element 42 at or close to the feeding terminal 22 instead of branching it midway along the folded monopole element 41 with the stub. That is, in this case, the capacitor element 5 is inserted only between the feeding terminal 22 and the stub of the folded monopole element 41 with the stub without being inserted between the monopole element 42 and the feeding terminal 22.

The antenna device shown in FIG. 18A is obtained by forming a distal end portion 426 of the monopole element 42 into a meandering shape.

The antenna device shown in FIG. 18B is obtained by forming a connection portion 427 between the monopole element 42 and the folded monopole element 41 with the stub into a wide portion.

The antenna device shown in FIG. 18C is obtained by providing a second monopole element 428 on the monopole element 42 in a direction opposite to the bending direction of the monopole element 42. Although FIG. 180 exemplifies the case in which the device includes one second monopole element 428, the device may include two or more second monopole elements.

The antenna device shown in FIG. 18D is obtained by inserting a lumped parameter element 64 in the monopole element 42 at a position close to the connection portion between it and the folded monopole element 41 with the stub. The lumped parameter element 64 is formed from an inductor and has a function of increasing the electrical length of the monopole element 42.

### (3) Modification of Passive Element 43

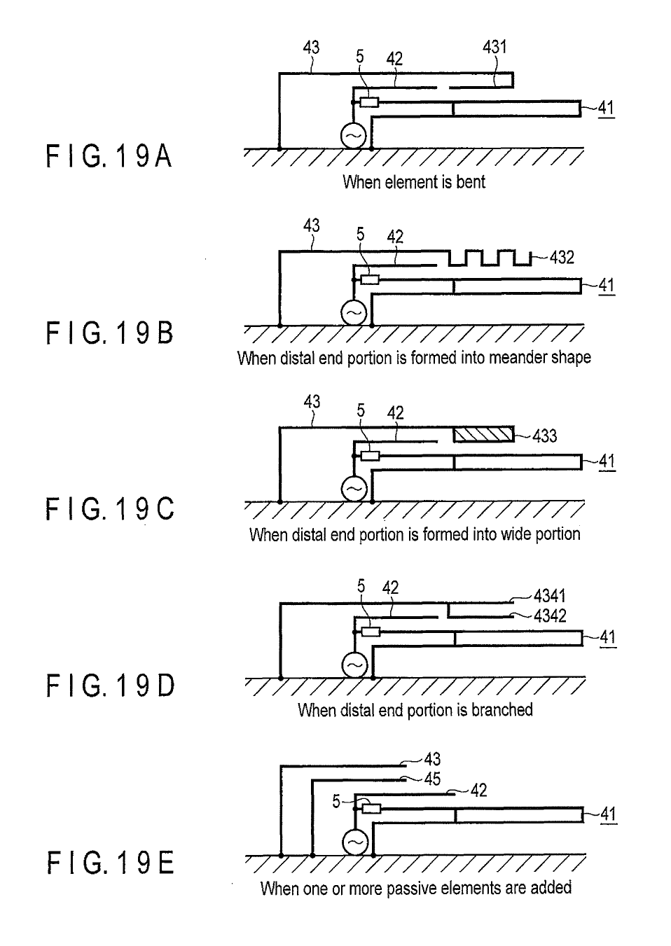

FIGS. 19A, 19B, 19C, 19D, and 19E, FIGS. 20A, 20B, 20C, and 20D, and FIGS. 21A, 21B, 21C, 21D, and 21E show various modifications of the passive element 43.

The antenna device shown in FIG. 19A is obtained by folding a distal end portion 431 of the passive element 43 in the direction of the monopole element 42.

The antenna device shown in FIG. 19B is obtained by forming a distal end portion 432 of the passive element 43 into a meandering shape. This arrangement can reduce the installation space in the element length direction of the antenna device even when the element length of the passive element 43 is long.

The antenna device shown in FIG. 19C is obtained by forming a distal end portion 433 of the passive element 43 into a wide plate-like shape. Note that the distal end portion 433 may be a rod having a larger diameter than the proximal end portion.

The antenna device shown in FIG. 19D is obtained by branching the distal end portion of the passive element 43 into a plurality of portions so as to provide a plurality of elements 4341 and 4342. Although FIG. 19D exemplifies the case in which the distal end portion is branched into two portions, the distal end portion may be branched into three or more portions.

The antenna device shown in FIG. 19E is obtained by providing a plurality of passive elements 43 and 45 between the feeding terminal 22 and a second ground terminal 32.

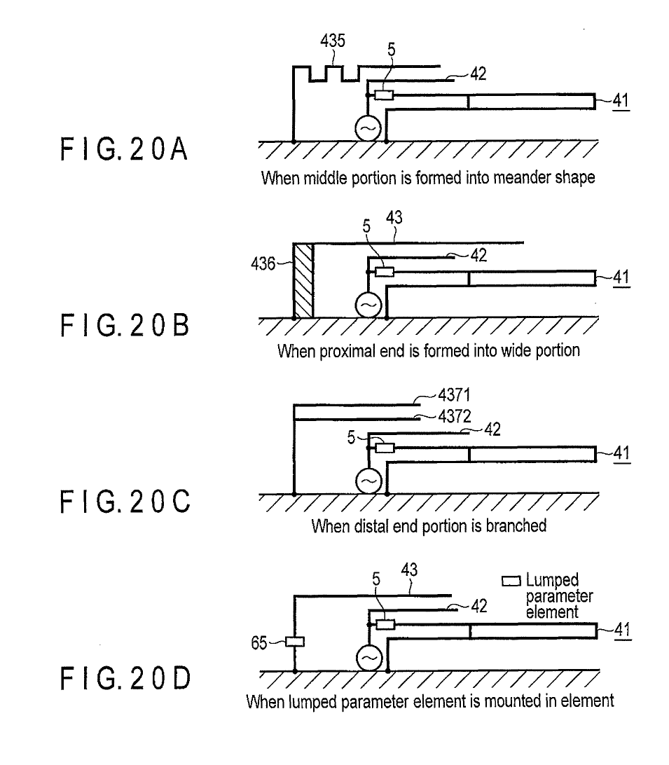

The antenna device shown in FIG. 20A is obtained by forming a middle portion 435 of the passive element 43 into a meandering shape. This arrangement can reduce the installation space in the element length direction of the antenna device when the element length of the passive element 43 is long.

The antenna device shown in FIG. 20B is obtained by forming a proximal end portion 436 of the passive element 43 which is located close to the second ground terminal 32 into a wide portion.

The antenna device shown in FIG. 20C is obtained by branching the passive element 43 at a position where it is bent in an L shape so as to provide a plurality of elements 4371 and 4372. Although FIG. 20C exemplifies the case in which the passive element is branched into the two portions, the element may be branched into three or more portions.

The antenna device shown in FIG. 20D is obtained by inserting a lumped parameter element 65 in the passive element 43 at a position close to the position at which the passive element 43 is connected to the second ground terminal 32. The lumped parameter element 65 is formed from an inductor and has a function of increasing the electrical length of the passive element 43.

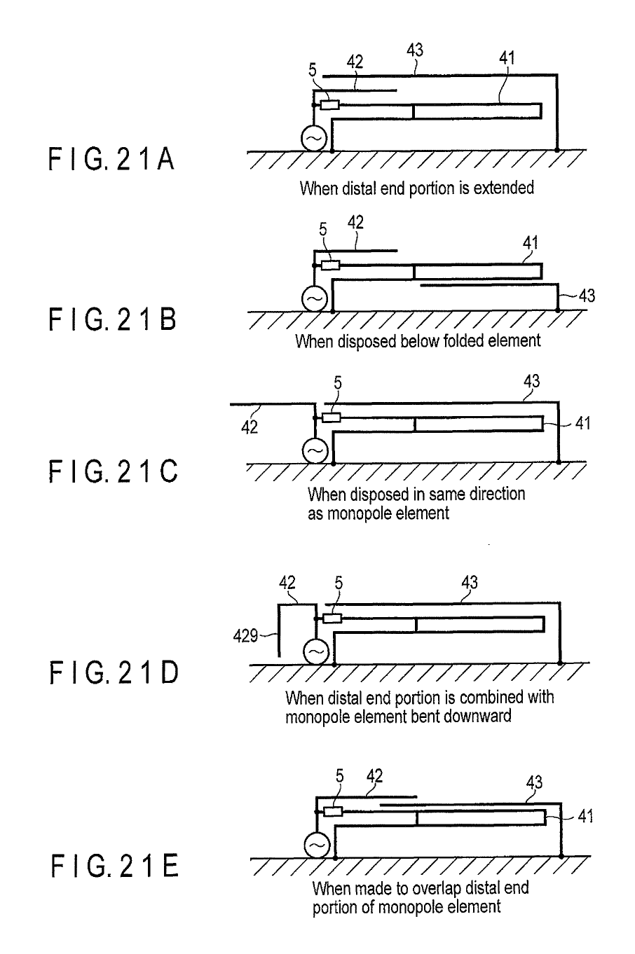

The antenna device shown in FIG. 21A is obtained by disposing the passive element 43 having an inverted L shape in a direction opposite to the folded monopole element 41 with the stub and the monopole element 42 while they overlap each other in the vertical direction.

The antenna device shown in FIG. 21B is obtained by disposing the passive element 43 between the folded monopole element 41 with the stub and the ground pattern 3. This arrangement can reduce the dimension of the antenna device in the height direction by reducing the installation space in the stacking direction of the elements 41 to 43.

The antenna device shown in FIG. 21C is obtained by disposing the monopole element 42 and the passive element 43 in a direction opposite to the folded monopole element 41 with the stub.

The antenna device shown in FIG. 21D is obtained by bending a distal end portion 429 of the monopole'element 42 toward the ground pattern.

The antenna device shown in FIG. 21E is obtained by disposing the passive element 43 in a direction opposite to the folded monopole element 41 with the stub and the monopole element 42, disposing the elements 41, 42, and 43 in the order named from the side close to the ground pattern 3, and making the distal end portion of the monopole element 42 overlap the distal end portion of the passive element 43.

In addition, the above embodiments can be executed by variously modifying the shapes, installation positions, and sizes of the folded monopole element with the stub, monopole element, and passive element, the type and arrangement of the electronic apparatus, and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An antenna device comprising:
a first antenna element comprising a folded monopole element having a first end connected to a feeding terminal, a second end connected to a first ground terminal, and a middle portion folded, with a stub being provided between a forward portion and a backward portion formed by the folding; and
a capacitor element inserted between the stub and the feeding terminal of the forward portion.

2. The device of claim 1, wherein when an electrical length of the first antenna element from the feeding terminal to the first ground terminal through the forward portion and the backward portion is set to substantially ½ a wavelength λ₁ corresponding to a preset resonance frequency f₁, a distance between the feeding terminal and the first ground terminal is set to not more than substantially ⅕ the wavelength λ₁.

3. The device of claim 1, wherein a capacitance C [pF] of the capacitor element is set within a range of 1/ω₁C<250 [Ω] where ω₁ is an angular frequency corresponding to the preset resonance frequency f₁.

4. The device of claim 1, wherein the first antenna element includes the stub at an arbitrary point between a middle position on the forward portion and the feeding terminal and the stub at an arbitrary point between a middle position on the backward portion and the first ground terminal.

5. The device of claim 1, further comprising a second antenna element comprising an L-shaped monopole element having a first end connected to an arbitrary point between the stub and the feeding terminal of the first antenna element, and a second end open, and wherein
the capacitor element is inserted between the feeding terminal and a connection point of the second antenna element with respect to the first antenna element.

6. The device of claim 5, further comprising a third antenna element comprising a passive element having a first end connected to a second ground terminal provided at a position on a side opposite to the first ground terminal through the feeding terminal, and a second end open, with at least a portion of the passive element being disposed parallel with the second antenna element so as to allow capacitive coupling thereto.

7. The device of claim 1, wherein the first antenna element which extends from an installation position of the stub to a folded end portion comprises one linear or plate-like element.

8. The device of claim 1, further comprising:
a printed wiring board including a first area in which the first antenna element and the feeding terminal are formed and a second area in which a ground pattern having a side partly formed into a substantially staircase pattern and the first ground terminal are formed; and
a feeding cable including a core disposed on the second area so as to protrude from the side formed into the staircase pattern into the first area, the protruding core being connected to the feeding terminal formed in the first area.

9. An electronic apparatus comprising:
a radio circuit configured to transmit and receive a radio signal; and
an antenna device connected to the radio circuit via a feeding terminal and a first ground terminal,
the antenna device comprising
a first antenna element comprising a folded monopole element having a first end connected to a feeding terminal, a second end connected to a first ground terminal, and a middle portion folded, with a stub being provided between a forward portion and a backward portion formed by the folding, and
a capacitor element inserted between the stub and the feeding terminal of the forward portion.

10. The apparatus of claim 9, wherein when an electrical length of the first antenna element from the feeding terminal to the first ground terminal through the forward portion and the backward portion is set to substantially ½ a wavelength λ₁ corresponding to a preset resonance frequency f₁, a distance between the feeding terminal and the first ground terminal is set to not more than substantially ⅕ the wavelength λ₁.

11. The apparatus of claim 9, wherein a capacitance C [pF] of the capacitor element is set within a range of 1/ω₁C<250 [Ω] where ω₁ is an angular frequency corresponding to the preset resonance frequency f₁.

12. The apparatus of claim 9, wherein the first antenna element includes the stub at an arbitrary point between a middle position on the forward portion and the feeding terminal and the stub at an arbitrary point between a middle position on the backward portion and the first ground terminal.

13. The apparatus of claim 9, further comprising a second antenna element comprising an L-shaped monopole element having a first end connected to an arbitrary point between the stub and the feeding terminal of the first antenna element, and a second end open, and wherein
the capacitor element is inserted between the feeding terminal and a connection point of the second antenna element with respect to the first antenna element.

14. The apparatus of claim 13, further comprising a third antenna element comprising a passive element having a first end connected to a second ground terminal provided at a position on a side opposite to the first ground terminal through the feeding terminal, and a second end open, with at least a portion of the passive element being disposed parallel with the second antenna element so as to allow capacitive coupling thereto.

15. The apparatus of claim 9, wherein the first antenna element which extends from an installation position of the stub to a folded end portion comprises one linear or plate-like element.

16. The apparatus of claim 9, further comprising:
a printed wiring board including a first area in which the first antenna element and the feeding terminal are formed and a second area in which a ground pattern having a side partly formed into a substantially staircase pattern and the first ground terminal are formed; and
a feeding cable including a core disposed on the second area so as to protrude from the side formed into the staircase pattern into the first area, the protruding core being connected to the feeding terminal formed in the first area.
